(19) United States
(12) Patent Application Publication
(10) Pub. No.: US 2025/0341241 A1
(43) Pub. Date: Nov. 6, 2025

(54) METHOD FOR CONTROLLING AN ELECTROMECHANICAL BRAKE

(71) Applicant: Robert Bosch GmbH, Stuttgart (DE)

(72) Inventors: Laszlo Boros, Ludwigsburg (DE); Simon Peter, Weil Der Stadt (DE); Simon Trautmann, Stuttgart (DE); Xi Nowak, Bisingen (DE)

(21) Appl. No.: 18/865,119

(22) PCT Filed: Jan. 25, 2024
(86) PCT No.: PCT/EP2024/051742

§ 371 Date: Nov. 12, 2024

(30) Foreign Application Priority Data
Mar. 10, 2023 (DE) 10 2023 202 169.2

(51) Int. Cl. F16D 65/18; F16D 121/24; F16D 125/40; F16D 127/06; F16D 129/08

(52) U.S. Cl. CPC F16D 65/18; F16D 2121/24; F16D 2125/40; F16D 2127/06; F16D 2129/08

(57) ABSTRACT

A method for controlling an electromechanical brake). The electromechanical brake includes an electric motor which acts on a brake actuator via a gear unit to generate a braking force. A switchable and bistable freewheel locking device, via which a brake release direction of the brake actuator can be locked, is provided to lock the gear unit. The method includes moving back the brake actuator after a braking operation by a fixed predefined distance and controlling the locking device to fix the brake actuator in the retracted position.

### FIELD

The present invention relates to a method for controlling an electromechanical brake. The present invention also relates to an electromechanical brake for carrying out the method.

### BACKGROUND INFORMATION

The service brake is usually a brake that uses brake fluid to press a brake piston together with a brake pad onto a brake disc to brake the vehicle. The parking brake, on the other hand, is configured as an electromechanical brake. As the electrification of units in motor vehicles increases, the service brake, too, should be configured as an electromechanical brake so that the need for brake fluid and the associated complex valve and line structure can be eliminated. Such an electromechanical brake could also significantly reduce maintenance costs.

U.S. Patent Application Publication No. US 2012/0073912 A1 describes a pneumatically or electromechanically actuated disc brake with a brake caliper that surrounds a brake disc. A brake actuating device comprising a rotary lever and at least one axially movable actuating spindle is disclosed as well, wherein the brake actuating apparatus is disposed in the brake caliper. A wear adjuster disposed in the brake caliper is disclosed, wherein the wear adjuster can be actuated by the rotary lever and serves to compensate a wear-related change in a clearance between a brake pad and the brake disc via axial adjustment of the at least one adjustment spindle. The wear adjustment includes a spur gear segment which engages in a crown gear that is functionally coupled to the at least one adjustment spindle, wherein the spur gear segment extends in a pivot direction of the rotary lever and is disposed on the rotary lever.

An object of the present invention is to be able to adjust wearing of the brake pad in a simple and cost-efficient manner.

The object may be achieved by a method with certain features of the present invention. Preferred example embodiments can be found in the disclosure herein.

### SUMMARY

The present invention provides a method for controlling an electromechanical brake. The electromechanical brake includes an electric motor which acts on a brake actuator via a gear unit to generate a braking force, wherein a switchable and bistable freewheel locking device, via which a brake release direction of the brake actuator can be locked, is provided to lock the gear unit.

The electromechanical brake is preferably a service brake. The gear unit can consist of one or more gear elements via which a rotational movement can be converted to a translational movement. The gear unit can also include gear elements that are used to create a transmission ratio. Brake actuators are components that are used to apply the braking force of the gearing onto a brake disc or drum to generate a braking torque. The brake actuator preferably includes a brake piston and/or S-cam and a brake pad.

According to an example embodiment of the present invention, the electromechanical brake comprises a bistable freewheel locking device. The locking device can be used to lock a movement of the gearing and thus of the brake actuator. The locking device accordingly has two switchable positions, namely a lock position in which the gear unit is locked and an unlock position in which the gear unit can move freely. Due to the bistability, the locking device is stable in both positions. In other words, the locking device can be held stable in both positions without current. The locking device also has freewheel properties. This means that the locking device locks only one rotation direction of the gear unit while an opposite rotation direction can move freely. According to example embodiment of the present invention, a brake release direction in which the brake can be released can be locked. The brake can therefore still be braked in the lock position of the locking device.

According to an example embodiment of the present invention, the method includes the steps of moving back the brake actuator after a braking operation by a fixed predefined distance and controlling the locking device to fix the brake actuator in the retracted position. Moving back the brake actuator can be actively caused by the electric motor or passively by a spring, for example. The moved back fixed distance is constant over the entire service life and preferably corresponds to a spacing between the brake pad and the brake disc or drum. A constant spacing between the friction partners can thus be maintained despite wearing of the brake pad, so that wearing of the brake pad can be compensated. Fixing the brake actuator in this position makes it possible to hold it with the spacing without current.

In a preferred embodiment of the present invention, the locking device is actively retracted before the brake is actuated. Actively retracting the locking device eliminates friction caused by the locking device, which eliminates any delay caused by deactivating the locking device and braking can thus be implemented more quickly.

In another preferred embodiment of the present invention, the locking device is deactivated by actuating the brake. Deactivation via actuation of the brake has the advantage that deactivation of the locking device is still possible even after failure of the active deactivation, so that the locking device is fail-safe.

The locking device is preferably activated when the vehicle is stationary and the brake is activated in order to create a parking brake. Activating the locking device locks the brake in a brake release direction. The locking device is held stable in this position so that the motor vehicle can be kept permanently braked when it is parked.

In an advantageous further development of the present invention, the fixed predefined distance is ascertained starting from a point of contact between friction partners of the brake. At the point of contact, the friction partners rest against one another. Starting from this point of contact, the spacing between the friction partners can be kept constant over the entire service life despite wear.

The point of contact is advantageously ascertained using values from a force sensor and/or torque sensor and/or force estimation/torque estimation. The point of contact can thus be ascertained using a simple force measurement or torque measurement/estimation. This enables a consistent accurate measurement of the point of contact.

In another advantageous embodiment of the present invention, the point of contact is ascertained using values of the motor current, the motor speed and/or the motor position. The motor values are typically already being measured. There is therefore no need for further sensors to ascertain the point of contact.

The underlying object of the present invention is further achieved by an electromechanical brake for carrying out such a method. The electromechanical brake comprises an electric motor which acts on a brake actuator via a gear unit to generate a braking force, wherein a switchable and bistable freewheel locking device, via which a brake release direction of the brake actuator can be locked, is provided to lock the gear unit. The electromechanical brake also comprises a control device which is configured to control the locking device to fix the brake actuator after the brake actuator is moved back. Such an electromechanical brake substantially achieves the advantages mentioned with respect to the methods.

According to an example embodiment of the present invention, the brake is a drum brake. A drum brake has the advantage that, due to its encapsulated design, it is resistant to dirt. Also, in a drum brake, the brake dust cannot escape to the outside. A drum brake is moreover significantly cheaper than a disc brake.

According to another example embodiment of the present invention, the brake is a disc brake. A disc brake has the advantage that it is much lighter than a drum brake, which improves suspension comfort. The heat dissipation of a disc brake is also better.

The ability to use both a disc brake and a drum brake for the electromechanical brake means that the brake can be optimally selected to fit the specific needs.

Embodiment examples of the present invention are shown in the figures and explained in more detail in the following description.

### BRIEF DESCRIPTION OF EXAMPLE EMBODIMENTS

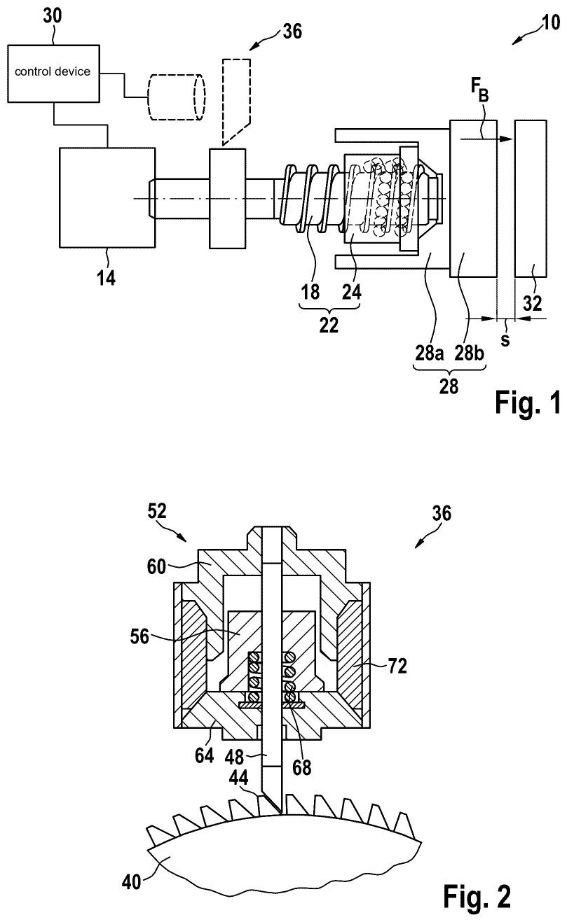

FIG. 1 shows an electromechanical brake according to a first embodiment example of the present invention.

FIG. 2 shows an embodiment example of a bistable locking device of the present invention.

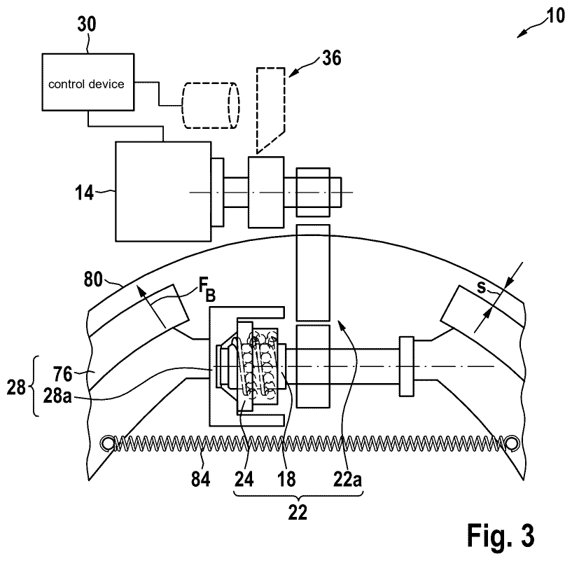

FIG. 3 shows an electromechanical brake according to a second embodiment example of the present invention.

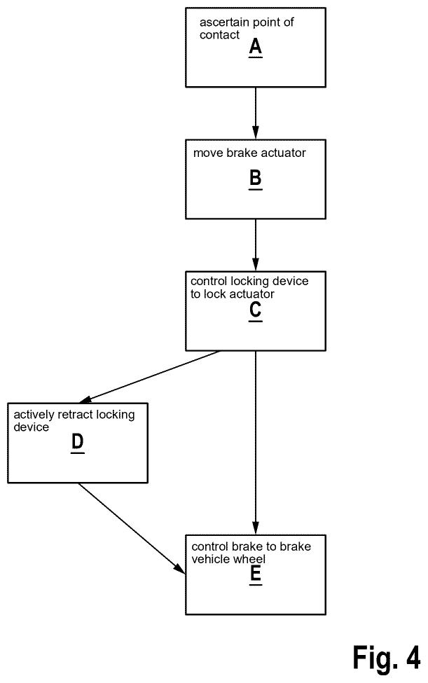

FIG. 4 shows an embodiment example of a method for controlling an electromechanical brake.

### DETAILED DESCRIPTION OF EXAMPLE EMBODIMENTS

FIG. 1 shows an electromechanical brake 10 according to a first embodiment example of the present invention. The electromechanical brake 10 comprises an electric motor 14 which acts on a spindle 18 of a gear unit 22 configured as a spindle gear arrangement. In the shown embodiment example, the spindle gear arrangement 22 is a ball-spindle gear arrangement. The spindle gear arrangement 22 also comprises a spindle nut 24, which acts on a brake actuator 28 to apply a braking force FB. The electromechanical brake 10 further comprises a control device 30 via which the electric motor 14 can be controlled. In the shown embodiment example, the brake actuator 28 comprises a brake piston 28a and a brake pad 28b. The brake pad 28b cooperates with a brake disc 32 to apply a braking torque.

The electromechanical brake 10 also comprises a locking device 36, with which the gear unit 22 can be locked. The locking device 36 can likewise be controlled by the control device 30. FIG. 2 shows an embodiment example of such a locking device 36. The locking device 36 is configured as a bistable freewheel locking device 36. For this purpose, the locking device 36 comprises a ratchet wheel 40 which is fixed on the spindle 18. The ratchet wheel 40 is configured as a type of gear wheel and the ratchet wheel 40 has sawtooth-shaped teeth 44. The locking device 36 also comprises a locking pawl 48, which can be brought into and out of engagement with the ratchet wheel 40 by means of a bistable electromagnet 52 in order to switch the freewheel. The position shown in FIG. 2 is an engaged position.

The electromagnet 52 comprises a block-shaped armature 56 to which the locking pawl 48 is attached. On a side of a housing 60 of the electromagnet 52 facing the ratchet wheel 40, it is closed with a permanent magnet 64. Disposed between the armature 56 and the permanent magnet 64 is a compression spring 68, with which a separation force is applied between the armature 56 and the permanent magnets 64. The electromagnet 52 also comprises a coil 72, via which the armature 56 is pulled to the permanent magnet 64. After the coil 72 is switched off, the armature 56 remains stable in this position due to the magnetic force between the permanent magnet 64 and armature 56.

Due to the sawtooth-shaped configuration of the ratchet wheel 40 and the corresponding configuration of the locking pawl 48, when the locking device 36 is in an engaged position, the ratchet wheel 40 is locked in one direction while being free to move in another direction. The locked direction corresponds to a release direction of the brake 10. Accordingly, a braking force FB is applied the ratchet wheel 40 is rotated in the free direction. A rotation in the free direction presses the locking pawl 48 upward by means of the teeth 44, so that the armature 56 is separated from the permanent magnet 64. The spring force pushes the armature 56 into the second stable position. In this position, the locking device 36 is in a pushed-out position.

The locking device 36 thus makes it possible to lock the brake 10 in a braked position in order to create a parking brake. The locking device 36 does not block movement of the brake actuator 28 in the braking direction.

FIG. 3 shows an electromechanical brake 10 according to a second embodiment example of the present invention. In contrast to FIG. 1, this brake 10 is a drum brake. In this embodiment example, too, an electric motor 14 drives a brake actuator via a gear unit 22. The gear unit 22 comprises a plurality of spur gears 22a and a spindle gear arrangement with which two drum brake pads 76 can be placed against a drum 80 in order to brake a wheel. The two drum brake pads 76 are connected to one another via a tension spring 84 so that they are loaded in a release direction. A locking device 36 with which the gear unit 22 can be locked, and which is shown in more detail in FIG. 2, is disposed here as well.

FIG. 4 shows an embodiment example of a method for controlling the electromechanical brake 10. In a first step A of the method, a point of contact between the friction partners, such as the brake pad 28b and the brake disc 32 of the brake 10, is ascertained. A not depicted force sensor which ascertains a braking force FB to be applied is used for this purpose, for instance. The point of contact can be ascertained from the braking force FB. In a next step B of the method, the brake actuator 28 is moved back after the braking operation by a fixed predefined distance. In order to be able to keep the brake actuator 28 de-energized, the locking device 36 is controlled in a next step C to fix the brake actuator 28. This brings the locking device 36 into an engaged position. Despite wearing of the brake pad 28b over its service life, these steps result in a constant spacing s (see FIG. 1) between the brake pad 28b, 76 and the brake disc 32 or drum 80.

The locking device 36 can be actively retracted D before the brake 10 is actuated. The brake 10 is then controlled to brake E the vehicle wheel. Alternatively, it is also possible to automatically deactivate the locking device 36 by actuating E the brake 10.

1-10. (canceled)

11. A method for controlling an electromechanical brake including an electric motor which acts on a brake actuator via a gear unit to generate a braking force, wherein a switchable and bistable freewheel locking device, via which a brake release direction of the brake actuator can be locked, is provided to lock the gear unit, wherein the method comprises the following steps:
moving back the brake actuator after a braking operation by a fixed predefined distance; and
controlling the locking device to fix the brake actuator in the retracted position.

12. The method according to claim 11, wherein the locking device is actively retracted before the brake is actuated.

13. The method according to claim 11, wherein the locking device is deactivated by actuating the brake.

14. The method according to claim 11, wherein the locking device is activated when the vehicle is stationary and the brake is activated in order to create a parking brake.

15. The method according to claim 11, wherein the fixed predefined distance is ascertained starting from a point of contact between friction partners of the brake.

16. The method according to claim 15, wherein the point of contact is ascertained using values from a force sensor and/or torque sensor.

17. The method according to claim 15, wherein the point of contact is ascertained using values of a motor current, and/or motor speed and/or motor position.

18. An electromechanical brake, comprising:
an electric motor which acts on a brake actuator via a gear unit to generate a braking force;
a switchable and bistable freewheel locking device, via which a brake release direction of the brake actuator can be locked, to lock the gear unit; and
a control device which is configured to control the locking device to fix the brake actuator after the brake actuator is moved back.

19. The electromechanical brake according to claim 18, wherein the brake is a drum brake.

20. The electromechanical brake according to claim 18, wherein the brake is a disc brake.
